(19) United States
(12) Patent Application Publication
(10) Pub. No.: US 2015/0316406 A1
(43) Pub. Date: Nov. 5, 2015

(54) Method and Apparatus for Locating Optimal Refueling Stations

(71) Applicant: Ford Global Technologies, LLC, Dearborn, MI (US)

(72) Inventors: Allan Roy Gale, Livonia, MI (US); David Allen Kowalski, Toledo, OH (US)

(73) Assignee: Ford Global Technologies, LLC, Dearborn, MI (US)

(21) Appl. No.: 14/265,726

(22) Filed: Apr. 30, 2014

(51) Int. Cl. G01F 23/00; G06Q 50/06; G06Q 20/18

(52) U.S. Cl. CPC G01F 23/0076; G06Q 20/18; G06Q 50/06

(57) ABSTRACT

The illustrative embodiments classify vehicle performance by fuel providers under a variety of driving demands. Individual measured performance may be combined with collaborative crowd-sourced experiences to leverage a vast data set usable to improve statistical accuracy. The illustrative embodiments provide non-limiting examples of methods usable to save fuel costs at the pump through the use of performance forecasts based on observed historic fuel quality at known fuel providers.

### TECHNICAL FIELD

The illustrative embodiments generally relate to a method and apparatus for locating optimal refueling stations.

### BACKGROUND

Drivers are expressing increasing interest in high mileage vehicles and express disappointment if the vehicle does not meet their mileage expectations. There are multiple factors to obtaining high mileage including obtaining a high mpg vehicle and learning to drive for high mpg. A factor often overlooked is the quantity and quality of fuel obtained for the vehicle (or even engine malfunction). A low quality fuel may result in lower fuel mileage as indicated by the vehicle mpg display or alternatively an overstated amount of fuel fill would result in a higher mpg on the mpg display than that observed by the vehicle owner after refill as well as a higher cost per mile traveled.

U.S. Application No. 2010/280956 generally relates to use of historic vehicle state information specifying a plurality of performance values associated with the plurality of subsystems of the vehicle at a plurality of time points, including a current time point, which is stored at the vehicle. Historic neighbor vehicle state information specifying a plurality of performance values associated with a plurality of subsystems of a vehicle at a plurality of time points, including a current time point is received from a neighbor vehicle proximate to the vehicle. A forward-looking model is generated based on vehicle state information. An performance value associated with a subsystem of the plurality of subsystems of the vehicle is determined based on the historic vehicle state information, the historic neighbor vehicle state information, and the forward-looking model. A recommendation to a driver of the vehicle is provided based on the optimized performance value.

### SUMMARY

In a first illustrative embodiment, a system includes a processor configured to register an amount of fuel dispensed to a vehicle. The processor is also configured to associate a fuel-dispensary with the amount of fuel. The processor is further configured to determine miles-per-gallon efficiency while the dispensed fuel is being used by the vehicle and save a record of the efficiency of the dispensed fuel, in miles-per-gallon, with respect to a record associated with the fuel-dispensary.

In a second illustrative embodiment, a processor is configured to receive a request to find a refueling point. The processor is further configured to obtain fuel station fuel-quality statistics for a plurality of fuel stations. Also, the processor is configured to determine a recommended fuel station from the plurality of fuel stations based on obtained fuel station fuel-quality statistics and present the recommended fuel station to the driver as a preferred fuel station.

In a third illustrative embodiment, a non-transitory computer-readable storage medium, stores instructions, that, when executed by a processor, cause the processor to perform a method including registering an amount of fuel dispensed to a vehicle. The method also includes associating a fuel-dispensary with the amount of fuel. Further, the method includes determining, via a vehicle computing system, miles-per-gallon efficiency while the dispensed fuel is being used by the vehicle. Additionally, the method includes saving a record of the efficiency of the dispensed fuel, in miles-per-gallon, with respect to a record associated with the fuel-dispensary.

### BRIEF DESCRIPTION OF THE DRAWINGS

FIG. 1 shows an illustrative vehicle computing system;

FIG. 2 shows an illustrative example of a process for identifying optimal refueling locations;

FIG. 3 shows an illustrative refueling recording process;

FIG. 4 shows an illustrative fuel usage tracking process;

FIG. 5 shows an illustrative example of a fuel usage and recommendation processing system;

FIGS. 6A and 6B show illustrative fuel usage reporting processes;

FIG. 7 shows an illustrative example of a fuel source determination process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

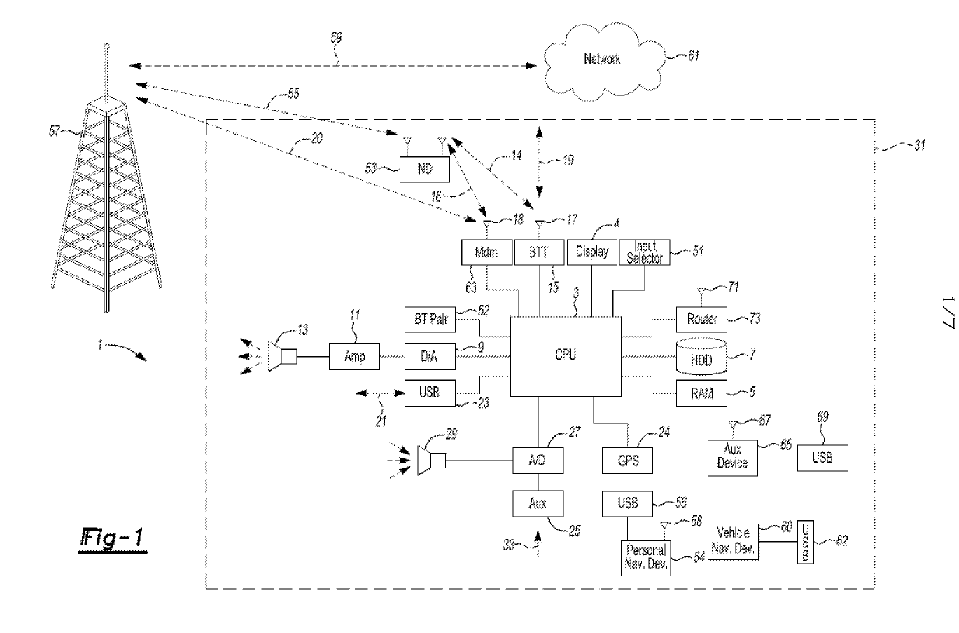

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a universal serial bus (USB) input 23, a global positioning system (GPS) input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a controller area network (CAN) bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, personal digital assistant (PDA), or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the central processing unit (CPU) is instructed that the onboard BLUETOOTH transceiver will be paired with a BLUETOOTH transceiver in a nomadic device.

Data may be communicated between CPU 3 and network 61 utilizing, for example, a data-plan, data over voice, or dual-tone multi-frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with mobile application software. The mobile application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 network (i.e., WiFi) or a 802.16 WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In many cases, owners would like to know where they are obtaining fuel that provides the best benefit to them. The information for parameters such as mileage at last fill up, current fill up, quantity of fuel added during a refill as measured by the car as well as measured by the pump via the billing agency along with the vehicle location and fuel price can be obtained from both the cloud and from newer vehicle instrumentation. Further, this information could be passed to the cloud to be incorporated with other vehicle data sets to enable others to look for unusual changes in the mean and the mode as well as other factors.

For the single user, this unusual but correct information could be reconciled if they were cause by irregularities of which the driver knew, such as weather and drive patterns. This information can be used to identify good or bad fuel-quality stations or even that the vehicle may be due for a tune up. The information may have value for regulatory agencies looking for mis-measuring fuel pumps, dealers interested in providing maintenance to the vehicle, other fuel providers to use for their advertising, or even manufactures to advertise the actual mileage of vehicle owners using their particular vehicle. While errors in the vehicle measurement system may lower the accuracy of the information for a single user, the cumulative information would be quite beneficial to both the customer and other information consumers.

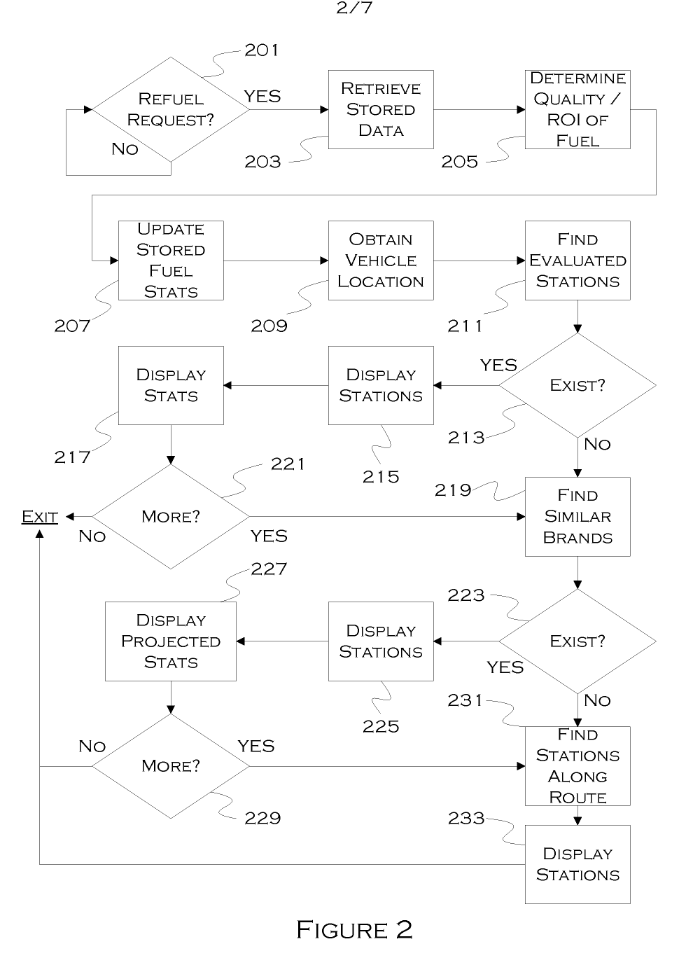

FIG. 2 shows an illustrative example of a process for identifying optimal refueling locations. The illustrative embodiments can be used to evaluate the effectiveness of fuel from varied stations on a particular vehicle. Since stations may use different purity levels of fuel, and may, unfortunately, sometimes engage in less than savory behavior, users (and, for example, regulators), can measure the effectiveness of fuel and levels of fuel output.

Also, users may want to know if a particular grade of fuel provides any increase in performance. Or if a particular brand of fuel provides any increase in performance. By tracking performance based on known, obtained quantities of fuel from known providers, the illustrative embodiments can gauge fuel usefulness and guide users to optimal refueling locations.

This data is useful for choosing refueling stations and, as such, needs to be delivered to drivers for utilization. The illustrative process demonstrates one exemplary manner of such delivery.

In this illustrative example, the process receives an indication that refueling is desired 201. This can be a driver initiated indication, or can be related to a low-fuel state of a vehicle. In response to the request, the process retrieves stored data relating to fuel usefulness from various locations 203. The data can be retrieved from a local data store, or from a remote cloud-based location. In one example, the data can be stored on a wireless device running the process or in communication with a vehicle running the process. Alternatively, the device may run the process and a given vehicle may store data for that vehicle.

At this point (or at some previous point, or continuously), the process may also determine the usefulness and/or return on investment of fuel 205. Since fuel is about to be added, changing the mixture of fuel in the tank, calculating the usefulness of the previously used fuel may be done prior to adding additional fuel. Fuel usage data may then be updated 207 in the appropriate data store (e.g., cloud, device, vehicle, etc.).

Also, because the process may be most concerned with providing fuel data to stations proximate to a user's vehicle, the process may obtain a current vehicle location 209. Within a given proximity of this location, the process may find fuel stations for which data currently exists 211. If statistics are stored locally, this data may correspond to stations that have been used by that particular vehicle. In other instances, the data may be obtained from the cloud and crowd-sourced, representing aggregate driver experiences.

Since fuel may vary from station to station, even within a given brand, the process first checks to see if any data exists for specifically identified stations in the area 213. As noted, this could be data observed by the vehicle system or data observed by crowd-sourced behavior.

If there are stations for which actual observations exist, the process may display these stations 215 for user perusal. In accompaniment to this display, the process can display the observed fuel usage statistics for these stations as well 217. This can be generalized data, or it can be specific data related to the particular vehicle. In the generalized case, the data can relate to vehicle classes, types, makes, models or just observed statistical performance in general. For example, the data can be presented in comparison to other local stations in some form that shows relative observed usefulness of local fuel (e.g., good, better, best, worse, worst, etc.).

Also, because actual observed data may be limited, the process may offer a user an opportunity to view data on additional stations 221. This data, which is the same data shown when no local, actual observed stations exists, relates to data saved with respect to a particular brand or provider of fuel 219. For example, if station brand X has been observed in fifty other local locations, but not in the immediate proximity, some form of average of the fuel statistics observed with respect to X can be used to “guess” the usefulness of the local station.

If there are any local brands that fit this model 223, the process can display those local stations 225 and the accompanying fuel statistics 227. Again, the process may also offer an opportunity for the user to view more data 229.

In this case, the “more” corresponds to the data that is shown when no local known brands exist. Since the system does not necessarily want to blindly guess at station fuel usefulness, a route may be observed and other stations for which data does exist may be found along the route 231. These stations, and the accompanying data, may then be displayed 233. Using all of this available data, the driver can make an educated decision about where to refuel. This will assist drivers in obtaining the most optimal fuel for their vehicles.

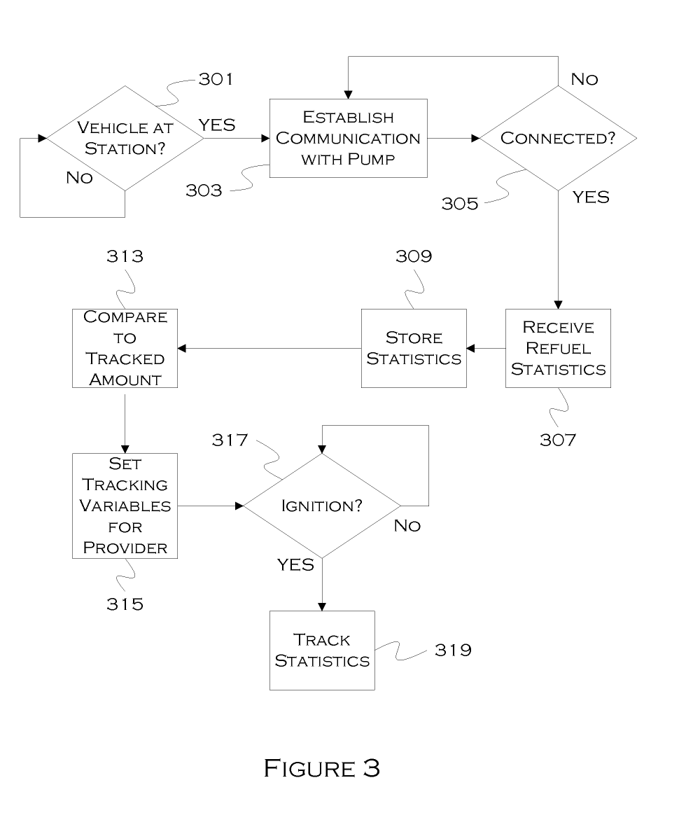

FIG. 3 shows an illustrative refueling recording process. This process is used to track the amount of fuel obtained at a given station. The process can work in conjunction with a device installed on a local pump to obtain a reading of the amount of fuel dispensed. This data can be compared to observed actual fuel in the vehicle. Other data, such as fuel blend, cost of fuel, temperature and other relevant information can also be recorded at this time, to observe the affects of additional variables on fuel consumption.

In this process, a check is made to see if a vehicle is at a local station 301. Since the data received relates to refueling, the process only progresses further, in this instance, when the vehicle is proximate to a refueling point. If the vehicle is present at a local station, the process establishes a connection with a fuel pump 303. As noted, the pump, or a device connected to the pump, may provide wireless data to vehicles. Since there are a number of pumps in close proximity, some additional identifier may be used to identify a specific pump being utilized. This can include some form of close range near field communication between a module in a pump handle and a module in a fuel port (engaging only when the handle is in close proximity to the port) or any other suitable method of correlating a pump with a vehicle.

Once the pump data unit and the vehicle (or mobile device) computer are connected 305, the process begins receiving statistics relating to the refueling 307. These statistics can be stored in a local or remote data store 309, for use when an analysis process analyzes the usefulness of fuel obtained at the particular station. Since more than one variable may affect fuel, and since fuel blends may vary over the seasons, even at a given station, the process may record this data so that no incorrect assumptions are made about fuel obtained at the station.

In one illustrative example, a value of fuel dispensed by the pump (according to the pump) can be compared to a tracked fuel actually entering the vehicle, to ensure that the pump is dispensing the actual amount it is registering, and/or to ensure that the vehicle is accurately measuring the amount of fuel incoming 313. In other examples, no communication between the pump and the vehicle is performed.

Also, tracking variables may be set at this time 315. Examples of these variables are discussed herein, and they generally relate to data about the fuel and data about the amount of fuel incoming versus the amount of fuel already present in the vehicle. Once the vehicle ignition is then engaged 317, the process can begin tracking fuel usefulness 319.

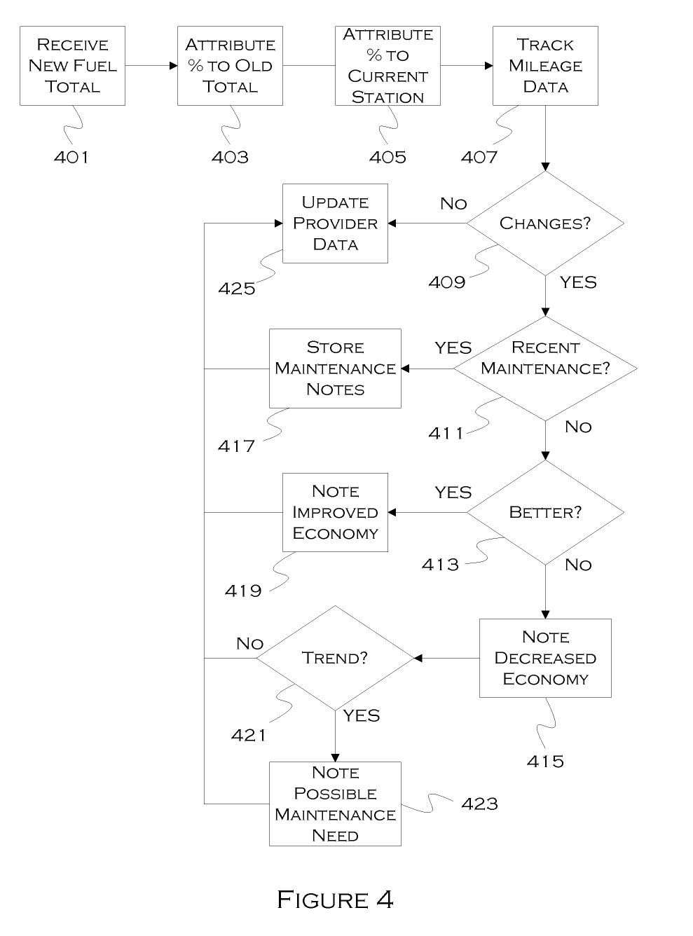

FIG. 4 shows an illustrative fuel usage tracking process. There are almost no instances when a driver replaces fuel in a vehicle and the vehicle fuel tank is completely empty. Instead, at some point before empty, the driver engages in a refueling process. This results in a blend of old fuel in a tank and the newly incoming fuel. This ratio can be used to weight the usefulness of any fuel calculation in a number of manners.

For example, if a user has refueled exclusively at one station for a long period of time, the observations may generally be expected to relate almost exclusively to data from that stations' fuel. On the other hand, if the user adds one gallon of fuel to an almost full tank, data observed relates very little to the added fuel. Data relating to fuel with low enough ratios can be ignored, data with very high ratios, or ratios above a threshold, can be recorded, and confidence data relating to a given ratio can even be recorded. Eventually, higher confidence data can gradually replace lower confidence data to give more accurate evaluations.

A new total amount of fuel, including refueling either observed or received from a vehicle connection to the pump, may be received by the process 401. This total includes both old fuel and the new fuel. Some percentage of the total amount of fuel may be attributed to the old fuel 403. The remaining percentage can be attributed to the newly added fuel 405. This allows the process to gauge a ratio of new fuel to old (or new to total) and thus gauge the usefulness of data relating to the newly added fuel.

Mileage data for the vehicle can then be tracked over time 407. Many modern vehicles can continually track changes in mpg being realized by the vehicle. This data, which may vary with speed, driving behavior, weather, traffic, etc., can be categorized by corresponding variables to ensure that observed mpg with respect to certain behavior corresponds to other data obtained under similar circumstances.

If there are any changes observed in measured mpg 409, additional measures can be taken to determine what may have caused the changes. If the measured mpg is the same, similar to, or within a tolerance of “standard” observed mpg for any given driving scenario 409, the process can update stored fuel data with respect to a given station 425. Again, the updating may also be based on the amount of “new” fuel being above a threshold ratio, and/or confidence data may be stored along with any stored observations.

If there are changes (or changes beyond a threshold), the process may check to see if recent maintenance has been performed on the vehicle 411. Records of maintenance may be stored in a vehicle memory or stored in a remote vehicle profile. If there has been recent maintenance, changes may be attributable to maintenance, and notes relating to the maintenance may be stored in conjunction with the fuel data 417. Over time, if the new data persists, the new post-maintenance data may replace the old pre-maintenance data.

If there has not been any recent maintenance, the process may check to see if the changes represent better 413 or worse (in this case, “not-better”) fuel economy. If the economy is improved, the process may note the improvement 419, which can be attributable, for example, to better fuel obtained from a given station. The data can also be attributable to other conditions, but if the data persists with respect to fuel from that station, the likelihood of the improvement being related to the fuel increases and may eventually be confirmed.

If the fuel economy has decreased, the process notes the decrease in economy 415 and attempts to determine if the decrease is seen in a trend across fuel from varied stations 421. If there is a general trend in decreased fuel economy, regardless of which station provided the fuel, it may be the case that some form of maintenance or vehicle upkeep is needed. Observation of such trends may cause the system to alert the driver to a recommended trip to the dealer 423.

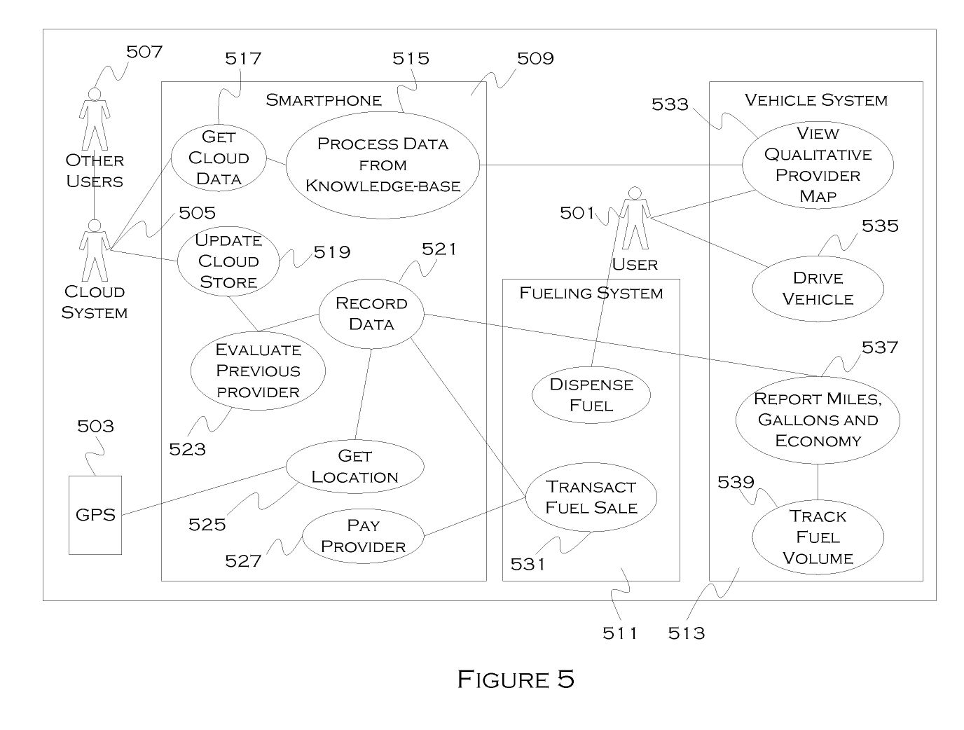

FIG. 5 shows an illustrative example of a fuel usage and recommendation processing system. In this illustrative example, a wireless device, such as a smart phone 509 works in conjunction with a fuel dispensing system 511 and a vehicle computing system 513.

Other users 507 contribute to a cloud-based system 505, which provides data to and receives data from a smart phone or wireless device application.

In this illustrative example, cloud-based crowd-sourced data is obtained by an application running on the smart phone 517. Data from the cloud-based knowledge base is processed by the application in accordance with, for example, GPS data 515 to obtain a qualitative provider map. The map is displayed on a vehicle computer 533 in this example, although it could also be displayed on a smart phone.

The user 501 also drives the vehicle in general 525, and data relating to economy and usage 537 is reported. This can be done in conjunction with tracking of fuel volume 539. When the user accesses a refueling station, fuel can be dispensed into the vehicle 529. As the sale of fuel is transacted 531, the smart phone process can record data relating to the fuel 521. The application may also be capable of providing a payment solution for the fuel 527.

Location data may be obtained by the smart phone, usable to identify the station and obtained from a GPS system 503. As new data is obtained, the old evaluation of the previous fuel 523 can be uploaded to the cloud to update current stored data 523.

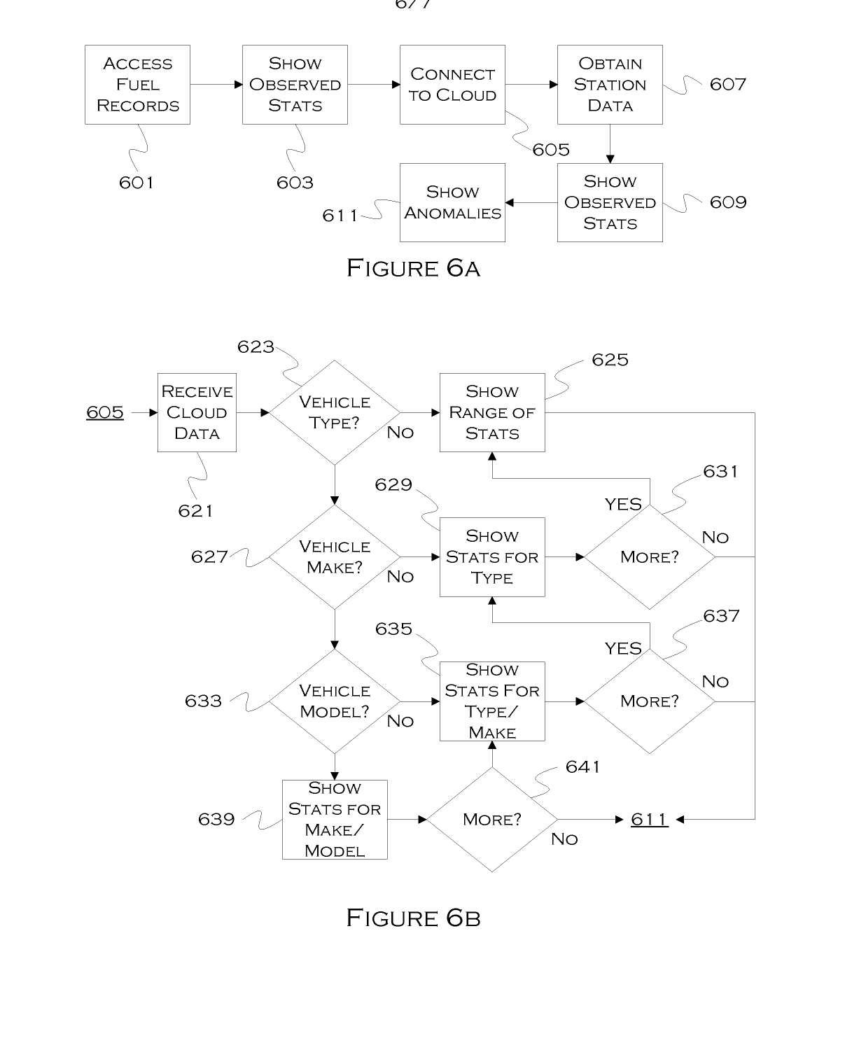

FIGS. 6A and 6B show illustrative fuel usage reporting processes. In FIG. 6A, the illustrative process displays information related to fuel statistics for various stations. This data includes “personally” observed statistics, crowd-sourced statistics, and fuel anomalies. In this instance, the anomalies correspond to fuel stations that are “better” or “worse” than statistical average stations.

Here, the process first accesses records relating to data observed by the current vehicle 601. This data can be stored in-vehicle, or can be stored in the cloud or on a mobile device. This data can be shown as the “real” data for this vehicle and/or vehicle/driver combination 603. Then, if additional data is desired, the process can contact the cloud for crowd-sourced data 605.

The crowd-sourced data relating to a given station or stations can be obtained 607, and can also be displayed 609. In conjunction with the display, anomalies can be identified for ease of user analysis 611. These anomalies can include stations of high value, low value, constantly varying value, etc. They can represent rankings of stations, one off observations, or other data that falls outside a “norm.” Just because a station has “better” gas, doesn't mean a user will necessarily want to use it. Proximity to route may matter too. But if a user can quickly see that a near-route station has “bad” fuel, and one somewhat off-route has “better” or “the best” local fuel, the user may be interested in traveling to the station.

Values of fuel may also be represented. It may be the case that the station with the “best” fuel also charges more. So a better value per dollar may be obtained by buying less efficient fuel from a cheaper source.

FIG. 6B shows an example of various types of cloud sourced data that may be shown. In this example, cloud data relating to a particular station or stations is received 621. First, in this example, the process checks to see if there is any data relating to a vehicle of a similar type (e.g., without limitation, “SUV”) 623.

If there is not such data available, the process may show a range of statistics for the station, for vehicles of varied types 625. For example, the process could show if the fuel from that particular station tends to be generally more or less useful than fuel from surrounding stations. Mpg statistics, relative levels of quality and other suitable information for vehicles in general could be shown.

If there is a vehicle of the specific type in the stored data, the process checks to see if there is a vehicle matching the current model in the stored data 627. For example, a certain model of SUV may be identified (e.g., without limitation, FORD EXPLORER). If there are no specific models matching the vehicle, the process may show stats for vehicles of a similar type/class 629. Also, the user may be presented with an option for more statistics 631, which in this case, corresponds to general statistics.

If there is data on vehicles of similar model, the process may then check for a given model year 633. In this case, the process will look for vehicles that are essentially the “same” as a current vehicle. If there are not vehicles of the given model, but not the given year, the process will show the data for vehicles of a similar model 635. If more data is requested 637, data for vehicles of similar types and/or general data may be shown.

Finally, if there are vehicles of the same model and year as the current vehicle, the process will show the statistics for vehicles and the same model/year 639. If additional stats are requested 641, the process will work backwards, as before, showing the preceding tiers of statistics. Tiers can be skipped, also, if desired. Using crowd-sourced data, the illustrative embodiments can amass a massive amount of statistical data in a short period of time. This data can then be sourced out to drivers and other entities for various uses, such as those set forth herein.

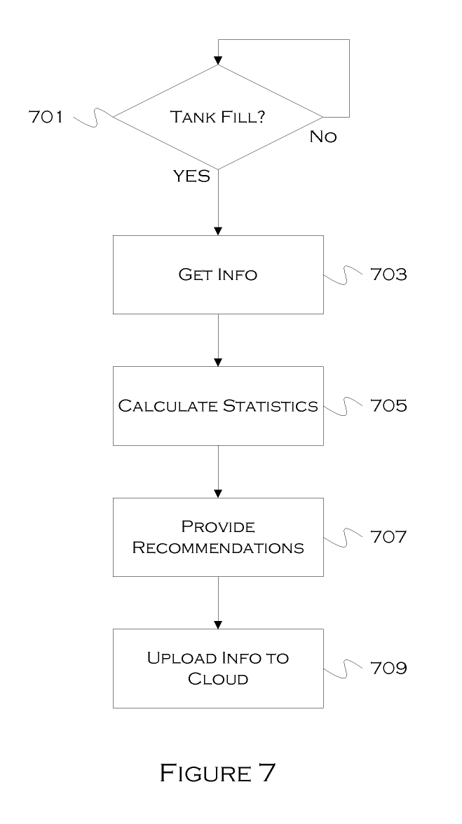

FIG. 7 shows an illustrative example of a fuel source determination process. In this illustrative example, the process determines whether or not a tank needs to be refilled 701. The refill determination can be based on, for example, a low fuel state or a driver request for fuel.

If the tank is to be filled, the process may gather information relating to refueling stations within the area 703. This can relate to, for example, refueling stations at or near a driver location, or could be, for example, refueling stations along a route. The information can also be based on observed driver experiences recorded at past refuelings, crowd-sourced data downloaded from a remote data base, or some combination of both. Other factors that reflect the value of the fuel obtained at various stations may also be included in the consideration.

Statistics are then calculated for the refueling stations 705, which demonstrate, for example, without limitation, whether or not the pumps are accurate, actual mileage obtained per dispensed gallon of fuel from each station, capability of fuel to meet vehicle demands, etc.

Based on the data and statistics, recommendations can be made to a driver as to preferred refueling stations 707. A “best” or a group of “best” stations may be presented, based on the statistics. The stations could also be ranked, if desired. Stations which the driver has not visited can be ranked based on crowd-sourced statistics, generic statistics, statistics for stations of a similar brand, or by any other suitable methodology.

As the driver refuels, relevant data can be tracked for gauging the truthfulness of the pump's reported amount dispensed. Usage of the fuel over time can provide statistics for the efficiency and usefulness of the pump's fuel in various situations. Any relevant information can then be uploaded to a cloud database 709 to be used in updating the crowd-sourced data.

Fuel can be evaluated on a variety of factors. A non-limiting list of factors upon which analysis may be provided includes, but is not limited to, refueling location, brand, vehicle type in which the fuel is analyzed, driving style of the driver while the fuel analysis is performed, mix of different drivers using a vehicle in which fuel is analyzed, fuel/pump performance in varied weather, fuel performance in traffic, etc. Much of this data also represents some form of “noise” that can server to skew statistics.

Using a neural network algorithm, the effect of noise in the analysis can be mitigated to some extent. Data can be weighted and certain data can be given higher preference as representative data based on frequency of occurrence. As patterns and consistency in observations emerge, these can be given preference as well, to further serve to limit the effect of outliers.

The accuracy of analysis based on dispensed fuel may vary. Some level of residual fuel typically remains in the tank, and this may be accounted for in the analysis. Insignificant refuels, e.g., a low percentage of total tank fuel added, may not result in analysis, since the results may be irrelevantly related to the new fuel. Observed levels of fuel may also be affected by fuel slosh motion and calibration errors in a fuel level reader. The time of day (temperature) and other weather factors, as well as tank geometry, may also be considered in analysis, as each may have some inconsistent effect on the outcome.

When a vehicle stops to refuel, statistical analysis data can be recorded. This includes data that may be useful in determining some set of reportable statistics with respect to any fuel dispensed. This data can include, but is not limited to, time, location, volume of fuel obtained, cost, current odometer mileage, fuel grade, brand, etc.

Errors in the above data may result from problematic conditions such as, but not limited to, pump cheats (over-reporting of fuel dispensed), fuel cheats (fuel grade actually lower than shown), a pump being out of calibration, fuel contaminates and/or a mix of old and new fuel in the vehicle. Over time, however, data may reveal these conditions at a given location, and will serve to warn drivers away from certain locations. The analysis and results of fuel obtained from these types of locations can then also be considered in light of known error-causing conditions.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
register an amount of fuel dispensed to a vehicle;
associate a fuel-dispensary with the amount of fuel;
determine miles-per-gallon efficiency while the dispensed fuel is being used by the vehicle; and
save a record of the efficiency of the dispensed fuel, in miles-per-gallon, with respect to a record associated with the fuel-dispensary.

2. The system of claim 1, wherein the processor is further configured to register a grade of fuel.

3. The system of claim 1, wherein the processor is further configured to register a cost of fuel.

4. The system of claim 3, wherein the processor is configured to save a record of the efficiency of the fuel in miles-per-dollar.

5. The system of claim 1, wherein the processor is configured to upload miles-per-gallon statistics, fuel data and fuel-dispensary data to a remote server for inclusion in a crowd-sourced fuel efficiency database.

6. The system of claim 4, wherein the processor is configured to upload miles-per-dollar data to a remote server.

7. The system of claim 1, wherein the processor is configured to provide payment for dispensed fuel, and exchange data relating to the dispensed fuel upon payment provision.

8. A system comprising:
a processor configured to:
receive a request to find a refueling point;
obtain fuel station fuel-quality statistics for a plurality of fuel stations;
determine a recommended fuel station from the plurality of fuel stations based on obtained fuel station fuel-quality statistics; and
present the recommended fuel station to the driver as a preferred fuel station.

9. The system of claim 8, wherein the request in driver-input.

10. The system of claim 8, wherein the request is automatically generated in response to a vehicle low-fuel state.

11. The system of claim 8, wherein the fuel stations are within a predefined proximity to a vehicle location.

12. The system of claim 8, wherein the fuel stations are within a predefined proximity to a current route.

13. The system of claim 8, wherein the fuel station fuel-quality statistics are obtained from a remote server and are based on crowd-sourced data.

14. The system of claim 8, wherein the fuel station fuel-quality statistics are based on data recorded by the vehicle being refueled at past instances of refueling.

15. A non-transitory computer-readable storage medium, storing instructions, that, when executed by a processor, cause the processor to perform a method comprising:
registering an amount of fuel dispensed to a vehicle;
associating a fuel-dispensary with the amount of fuel;
determining, via a vehicle computing system, miles-per-gallon efficiency while the dispensed fuel is being used by the vehicle; and
saving a record of the efficiency of the dispensed fuel, in miles-per-gallon, with respect to a record associated with the fuel-dispensary.

16. The storage medium of claim 15, the registering including a grade of fuel.

17. The storage medium of claim 15, the registering including a cost of fuel.

18. The storage medium of claim 17, the saving including a record of the efficiency of the fuel in miles-per-dollar.

19. The storage medium of claim 15, further comprising uploading miles-per-gallon statistics, fuel data and fuel-dispensary data to a remote server for inclusion in a crowd-sourced fuel efficiency database.

20. The storage medium of claim 15, the method further comprising providing payment for dispensed fuel, and exchanging data relating to the dispensed fuel upon payment provision.
